(19) United States
(12) Patent Application Publication
(10) Pub. No.: US 2007/0147738 A1
(43) Pub. Date: Jun. 28, 2007

(54) INTRINSIC FABRY-PEROT STRUCTURE WITH MICROMETRIC TIP

(76) Inventors: Xingwei Wang, Lowell, MA (US); Juncheng Xu, Blacksburg, VA (US); Zhuang Wang, Spring, TX (US); Anbo Wang, Blacksburg, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/609,655

(22) Filed: Dec. 12, 2006

Related U.S. Application Data
(60) Provisional application No. 60/749,090, filed on Dec. 12, 2005.
(60) Provisional application No. 60/749,093, filed on Dec. 12, 2005.

(51) Int. Cl. G02B 6/42; G02B 6/26; G02B 6/00

(52) U.S. Cl. 385/43; 385/12; 385/31; 385/37; 385/39

(57) ABSTRACT

A fiber-optic sensor includes a Fabry-Perot cavity, the length of which may be altered by deposition of a material of interest that may be deposited or captured on an end surface thereof. The sensor may also be tapered near the end surface to a tip diameter in the range of a few micrometers or a few micrometers by a variety of techniques which may be used singly or in combination. A tapered probe of such dimensions is of minimal intrusiveness in biological observations and can be used to probe sub-micron sized cells in vivo. By developing a multi-layer self-assembled film to immobilize a capture material such as a DNA sequence complementary to a DNA sequence of interest or other organic material such as proteins, antigens and/or antibodies materials of interest may be preferentially captured and immediately detected by alteration of spectral response of the fiber-optic sensor.

### CROSS-REFERENCE TO RELATED APPLICATIONS

This application claims benefit of priority of U.S. Provisional Patent applications 60/749,090 and 60/749,093, both filed Dec. 12, 2005, and both of which are hereby fully incorporated by reference as if fully set forth herein.

### BACKGROUND OF THE INVENTION

1. Field of the Invention

The present invention generally relates to a fiber-optic sensor structure and method for fabricating and using the same and, more particularly, to a fiber-optic sensor employing a Fabry-Perot cavity and an extremely fine probe tip particularly suitable and advantageous for biological measurements including detection of antigens/antibodies and other proteins and DNA sequencing.

2. Description of the Prior Art

Fiber-optic devices have been known for a number of years and are basically waveguides capable of directing electromagnetic energy such as light along its length with relatively small loss and internal scattering of that energy. Thus fiber-optic cables have become popular signal transmission media since they are not subject to electro-magnetic interference and exhibit very large bandwidth corresponding to the relatively short wavelengths of electromagnetic energy (e.g. light) generally employed.

Fiber-optic devices have also become popular for use as sensors and many different configurations are known for measurement or detection of many different conditions (e.g. temperature, pressure, fluid level, fluid flow rate and the like) and fiber-optic sensor structures are often combined with fiber-optic cables for remote sensing applications. Such combinations of fiber-optic sensor structures and fiber-optic communication links have the additional particular advantage of minimizing the structure required at the sensor itself and which can often be limited to a few reflecting and/or partially reflecting structures within or applied to a fiber-optic element.

Many fiber optic sensor structures exploit the sensitivity engendered by the relatively short wavelengths of electromagnetic energy generally employed which is often in the visible spectrum and near-infrared and near-ultraviolet range. For example, if electromagnetic energy is partially reflected and partially transmitted by one surface and the transmitted energy reflected from another surface spaced therefrom, forming a difference in lengths of optical paths (often referred to as an optical path difference or OPD), interference effects will cause a distinct, quantitatively predictable and readily detectable change in the amount of returned energy as the spacing between the two surfaces varies with the condition of interest. Other effects which effectively change a dimension in the fiber-optic sensor such as physical elongation or compression, change of refractive index and/or deposition or removal of material may also be used in much the same manner.

The sensitivity to such a change in dimensions may often be enhanced by particular structures in the fiber-optic sensor. For example, a so-called Fabry-Perot (FP) cavity can produce resonance effects in the sensor when the cavity length between partially or fully reflecting surfaces is an integral multiple of the wavelength of the electromagnetic energy used in the sensing process. The match or mismatch between reflectivities of structures defining the FP cavity can also be readily detected and evaluated for purposes of sensing or measurement of particular conditions at the sensor.

Despite the versatility of sensors formed in accordance with principles of fiber-optics or any of a number of other technologies, some parameters and conditions of interest remain notoriously difficult for measurement or detection. Many such currently available measurement or detection techniques which have presented difficulty include sources of high cost, criticality or potential unreliability and may entail causing gross changes in the measurement or sensing environment, particularly in biological measurements and detection, especially intracellular and in-vivo biological studies. For example, dimensional measurements at very small scale such as in a micron-sized cell are typically performed by comparison of dimensions using a microscope (e.g. optical, electron microscope or the like, possibly augmented by instrumentation of some type) while detection or measurement of concentration of particular chemicals generally require a selective chemical label or indicator such as a fluorescent dye (many of which are subject to photobleaching as well as being of substantial cost and generally requiring well-developed skills for their use) as well as highly expensive instrumentation and sophisticated numerical algorithms in order to interpret the observations made; which interpretation is thus also very time-consuming. These problems are particularly acute in regard to detection of base sequences of deoxyribonucleic acid (DNA) and other complex organic chemicals such as particular proteins, antibodies and antigens; which detection is of great importance in many fields such as genetics, pathology, pharmacogenetics, food safety, criminology, civil defense, energy production, disease detection and diagnosis, intracellular surgery and the like where rapid availability of results may also be of significant importance. Such complex and time-consuming detection by known techniques precludes such applications as immediate detection of biological and other potentially dangerous chemicals in airports, subways and similar environments.

### SUMMARY OF THE INVENTION

It is therefore an object of the present invention to provide a probe of micrometer or nanometer dimensions capable of making measurements in micron-sized environments such as cells with minimal intrusiveness and which does not require use of selective labels or indicators such as dyes.

It is another object of the invention to provide a new measurement technique which is capable of direct and immediate detection and/or measurement with high reliability and reduced criticality and/or measurement at very low cost and using simple and robust procedures and sensors.

In order to accomplish these and other objects of the invention, a fiber optic sensor is provided comprising a first reflector, a second reflector spaced from the first reflector and formed by an end surface of the fiber-optic sensor wherein the end surface includes an arrangement or material for capturing a material thereon and wherein the first reflector and the second reflector form a Fabry-Perot cavity which is variable in length by a thickness of material captured on said end surface.

In accordance with another aspect of the invention a method of making a fiber-optic sensor is provided comprising steps of forming a Fabry-Perot cavity, attaching a communication fiber at a first end of the Fabry-Perot cavity, and depositing a material on a second end of said Fabry-Perot cavity, which material is capable of capturing a thickness of additional material which, in turn, alters an effective altering a length of the Fabry-Perot cavity.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic diagram of the Fabry-Perot (FP) structure of the invention in accordance with its basic principles,

FIG. 2A is a schematic diagram of a preferred embodiment of the invention and comparison with a 125 μm commercially available optical fiber,

FIGS. 2B and 2C illustrate the spectral effects of the invention in air and water environments respectively,

FIGS. 3A, 3B and 3C illustrate basic steps in forming the FP sensor in accordance with the invention,

FIGS. 4A, 4B 4C and 4D illustrate exemplary etching techniques for forming tapered probes preferred for utilization of the invention in many applications,

FIGS. 5A, 5B, 5C and 5D illustrate alternative forms of a variant structure in accordance with the invention, and

FIGS. 6A and 6B illustrates a preferred application for the invention to provide DNA detection in a manner not previously possible.

### DETAILED DESCRIPTION OF A PREFERRED EMBODIMENT OF THE INVENTION

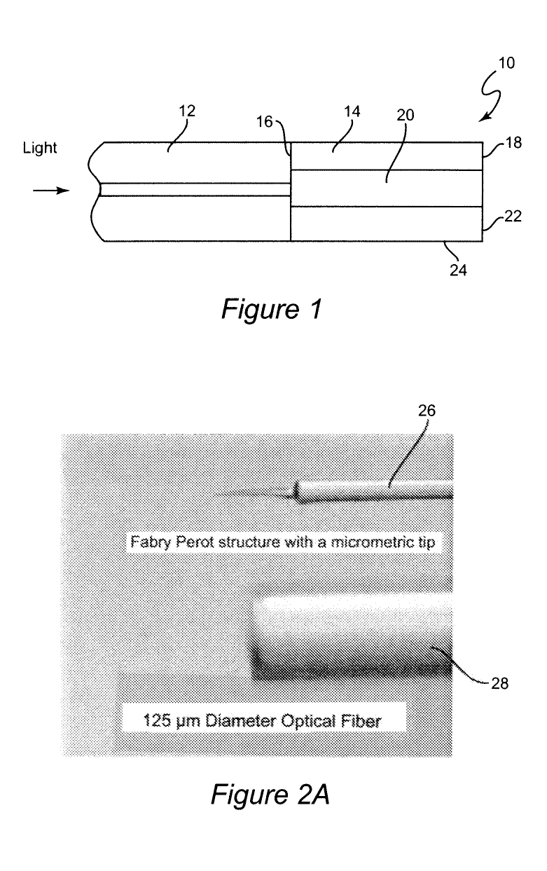

Referring now to the drawings, and more particularly to FIG. 1, there is shown a schematic diagram of the Fabry-Perot (FP) structure of the sensor 10 in accordance with the basic principles of the invention. The sensor in accordance with the basic principles of the inventions employs two different mode field diameter (MFD) optical fibers 12, 14 and produces a first reflector 16 at the interface thereof. Other structures can be used in place of the first reflector and are not limited to surfaces, such as a Fiber Bragg (diffraction) grating (FBG) as will be described below as an exemplary structural variant of the invention.

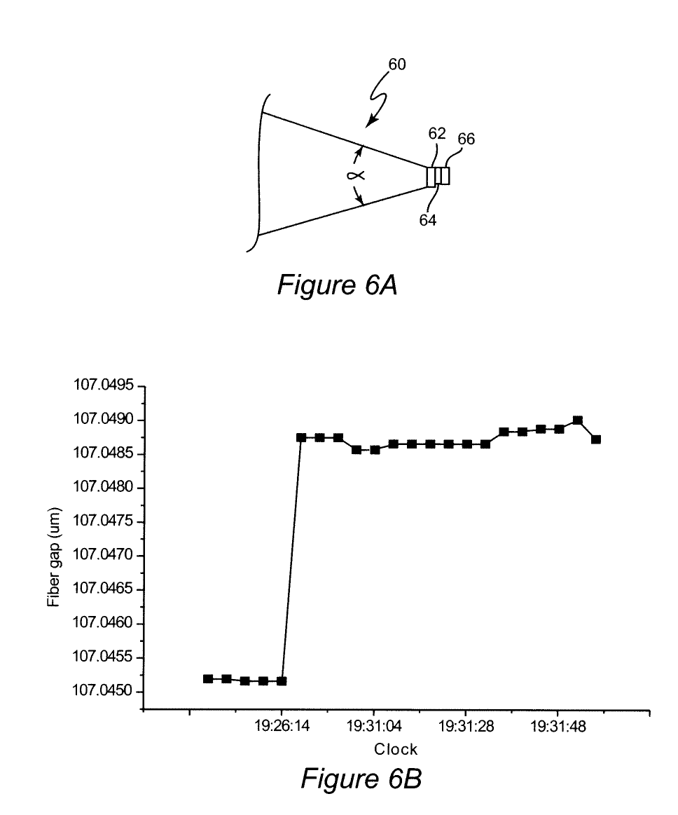

A second reflector 18, defining the FP cavity 20 between the reflectors, is preferably produced by cleaving the distal end of the fiber. It should be appreciated that the second reflector, even if so constituted by cleaving the optical fiber, is subject to modification in effective position by deposition of material thereon (as shown in FIG. 6B) which effectively elongates the cavity (since the reflection is principally caused by the change in refractive index at the end of the structure including material deposited thereon), the refractive index of the surrounding environment and the like as well as by dimensional changes in the optical fiber, itself, due to conditions such as temperature and/or pressure. The second reflector may be metallized with, for example, a film 22 of gold or aluminum to increase reflectivity or may be used as a partial reflector in connection with a further reflective or partially reflective surface in some applications. Such metallization 24 can also be applied on the sides of the cavity to better confine light or other electromagnetic energy therein and is preferred to minimize transmission efficiency effects of tapering of the probe tip to desired dimensions as will be described below.

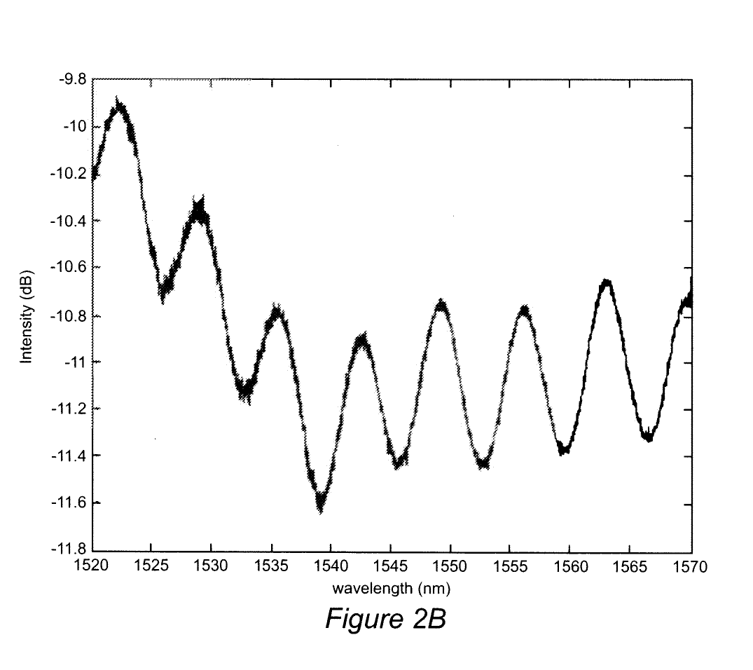

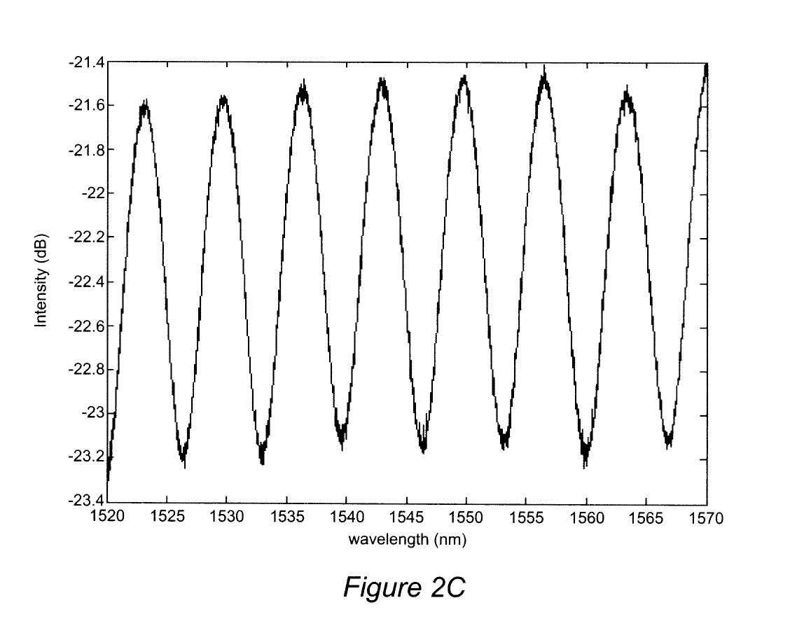

The first and second reflectors (and other reflectors that may be provided at various axial positions such as external surfaces to be detected or one or more additional cavities formed by, for example, a hollow fiber sandwiched between two fiber cores) thus define optical path length(s) which will resonate at particular wavelengths which are sub-multiples of the cavity length(s) and which thus affect the spectrum of electromagnetic energy reflected from the sensor/FP cavity and also provides for calibration for correction of effects of temperature and/or pressure. The visibility of the reflected spectrum can be maximized by matching the reflectivity of the first and second reflectors as may be appreciated from a comparison of the sensor spectral responses in air and water as illustrated in FIGS. 2B and 2C, respectively; an effect that also allows discrimination of various parameters and conditions which may be of interest such as detection of particular materials in the environment of the second reflector and/or discriminating between effects of multiple effective second reflectors. Reflectivity of the first reflector can also be adjusted by selection of MFD fibers employed to form the fiber junction interface. Similar reflectivity adjustments may be performs with a FBG as discussed below.

The first reflector, when constituted by a reflective surface, is preferably formed using only a splicing technique; many suitable forms of which are well known and understood in the art. Any combination of different MFD fibers may be used, including (without limitation) a single mode fiber with a multi-mode fiber, single mode or multi-mode fibers with different core sizes, a standard fiber with a customized (e.g. including different dopant or having a different or graded index of refraction and so on). The FP cavity can be formed in either of the two fibers having different MFDs and, conversely, it is immaterial to the successful practice of the invention which of the different MFD fibers is used for optical communication to and from the sensor.

It should be appreciated that while the structure illustrated in FIG. 1 provides a FP cavity in accordance with the invention and is sufficient to the successful practice thereof, it is preferred to provide a probe tip having a diameter which is on the order to a micrometer to a nanometer as is evident from a comparison of the probe tip of a preferred form of the invention 26 with a 125 μm fiber 28 as is illustrated in FIG. 2A. This probe, optionally but preferably including a micrometer or nanometer protrusion can be created in a number of ways which will now be explained.

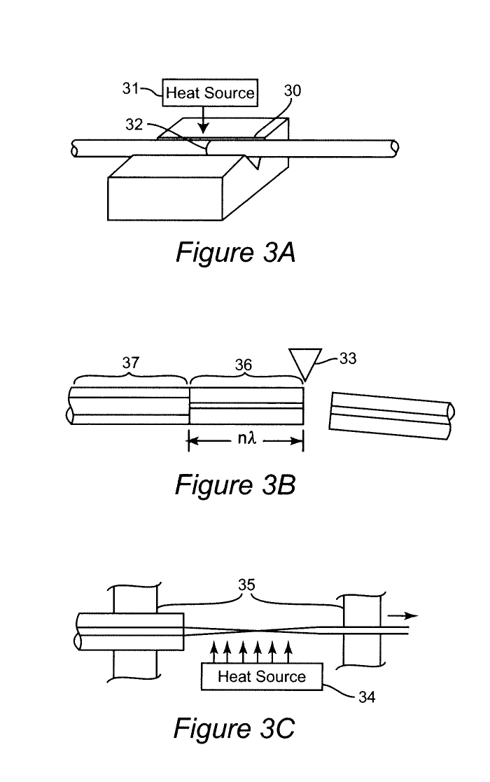

As shown in FIG. 3A, two optical fibers having different MFDs are spliced by bringing them into axial registration (preferably with a suitable tool such as V-groove 30) and applying heat from a heat source 31 such as a laser to fuse them together, forming junction 32. Alternatively, optical adhesives and greases are known which are suitable for splicing the optical fibers. Any of these techniques is suitable to form a junction which is partially reflective due to the mismatch between the MFDs of the respective optical fibers. Then, as shown in FIG. 3B one of the fibers is cleaved using a suitable tool schematically depicted at 33 near the junction of the fibers formed in accordance with FIG. 3A. The proximity to the junction is not critical to the successful practice of the invention in accordance with its basic principles but should be chosen in accordance with requirements for FP cavity length which principally corresponds to the desired wavelength of electromagnetic energy used to operate the sensor. Since the location of the splicing point or junction of the fibers can easily be investigated and observed with a 40× optical microscope, the cleaving point and cavity length can be readily controlled down to micrometer tolerance. Gross cavity length is also non-critical to the successful practice of the invention and can be on the order of micrometers to millimeters; depending principally on the desired probe tip shape, including diameter length and taper.

Upon cleaving one of the optical fibers at a desired point, the FP cavity is formed sufficiently for the sensor to operate although additional processes may be employed in connection with particular applications of the sensor such as DNA base sequence detection as will be discussed in greater detail below. However, the diameter of the probe tip will be that of the optical fiber which is cleaved while a much smaller diameter may be desirable, particularly to reduce intrusiveness of use of the probe in biological applications.

Tapering of the fiber may be accomplished in several preferred ways which will now be discussed and which will lead others skilled in the art to additional techniques for achieving such a tapered shape. One suitable technique, illustrated in FIG. 3C, is simply heating and pulling the end of the fiber, preferably preceding the cleaving process since the FP cavity length would otherwise be altered by the process. Heating and pulling also may introduce irregularities in the taper or otherwise compromise repeatability of a particular tapered probe shape although the amount of taper is not critical to the reproducibility of measurements made using different sensors although it may be important to the environment of the measurement such as biological applications. Current heating and pulling techniques are sufficiently developed at the current state of the art to avoid introducing axial shifts during the process. However, care should be taken, nonetheless, to avoid variation of the optical axis within the tapered regions if heating and pulling techniques are employed. The heated area, temperature and timing of the heating and pulling substantially affect the tip shape as will be evident to those skilled in the art. However, heating and pulling provides an advantage in that the surface of the tapered portion is very smooth and tip shape reproducibility is very high once the parameters of the heating and pulling process are determined or optimized.

In this technique, heating is preferably performed using a CO₂ laser 34 and pulling is preferably accomplished using a commercially available pipette puller 35. When a pre-set pulling velocity is reached, the laser is switched off and after a suitable delay, a hard pull is exerted on the fiber to separate the pulled parts close to the location of the minimum diameter achieved (e.g. as an alternative to a separate cleaving operation). While heating and pulling techniques are effective to produce longer tapers than can generally be formed by etching, it is difficult to produce an apex diameter of less than 50 nm. Longer and more gradual tapers generally have reduced transmission efficiency for a given tip aperture diameter. Therefore, the limitation on tip diameter using heating and pulling techniques actually serves to enhance manufacturing yield of usable probes. Tip diameter can also be further reduced by etching as will be described below to the extent that transmission efficiency allows. Long taper probes also provide a somewhat less robust structure although it has been found that long taper probes have a low incidence of breakage and will bend elastically when force is applied thereto.

As an alternative to heating and pulling, the taper can be achieved by any of a number of etching processes including but not limited to meniscus etching, selective etching, tube etching, sealed tube etching and Kwong-Li etching which are detailed in “Label-free DNA Sequence Detection Using Oligonucleotide Functionalized Fiber Probe with a Miniature Protrusion” by Xingwei Wang (a doctoral dissertation submitted to the Faculty of Virginia Polytechnic Institute and State University, Blacksburg, Va., Aug. 8, 2006) which is hereby fully incorporated by reference as if set out herein in its entirety.

Etching for forming a tapered probe tip is preferably performed by dipping the fiber into a hydrofluoric acid (HF) solution together with various manipulations in accordance with various etching techniques. The advantage of etching is that a sensor with a high/large tip cone angle and an arbitrarily small tip size can be produced easily, reliably and repeatably using only a single process step. (The high/large cone tip angle and the consequent relatively short probe length increases transmission efficiency such that the actual aperture tip diameter can be made arbitrarily small consistent with functionality and high manufacturing yield. The disadvantage of etching is that a significantly rougher surface will result; causing somewhat increased energy loss in the tapered probe tip.) Etching may also extend as far along the sensor 36 and communication fiber 37 as may be desired. That is, the junction 32 may be etched if necessary to achieve the desired taper if the desired taper length is longer than the FP cavity but is seldom necessary unless the probe/sensor is longer than several millimeters. The etching process is influenced by a number of parameters including concentration of HF in the etching solution, the possibility of using an organic solvent layered on top of the HF solution, etching time and the type of fiber and/or dopant and other environmental factors.

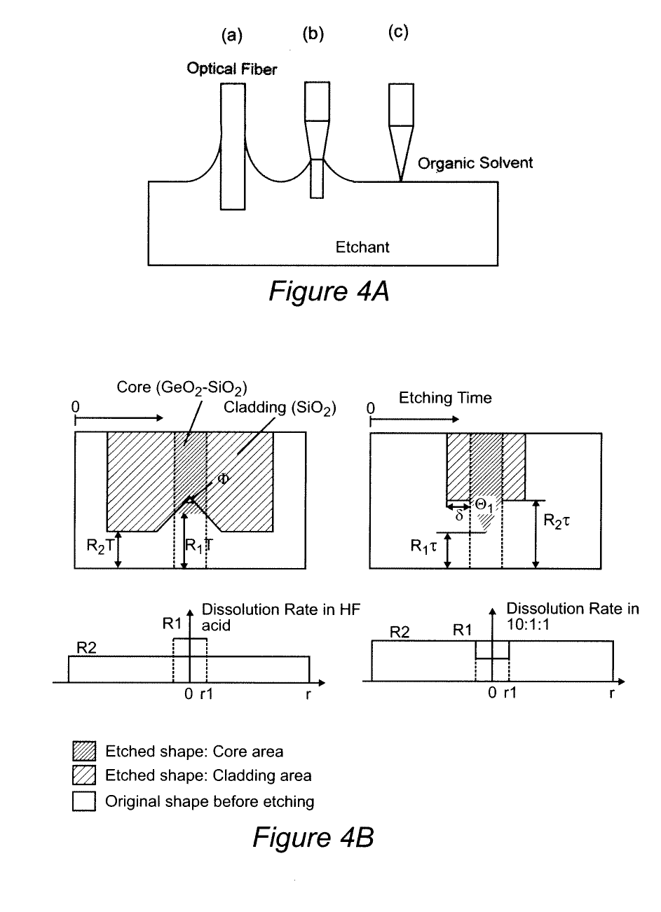

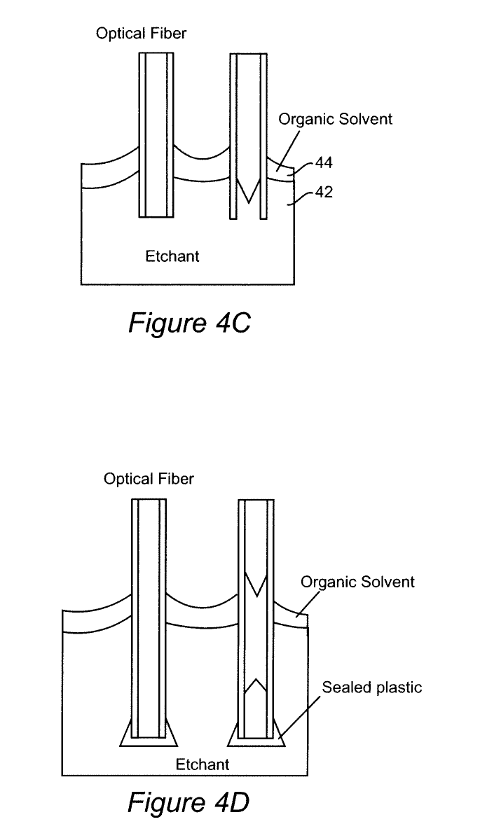

Meniscus etching involves forming a meniscus along the fiber tip during the etching process and has the advantage of preventing corrosion above the etchant surface or tip region of the probe due to etchant vapor. To achieve these advantages, a protective layer of hydrophobic chemical such as toluene or p-xylene covering the etchant surface as shown in FIG. 4A. As illustrated therein, the fiber is dipped into a stacked solution of etchant and etchant-insoluble organic solvent or oil, forming a well-regulated etchant surface meniscus around the fiber such that etching occurs only where the fiber is in contact with the etchant below the organic solvent or oil. Further, the meniscus limits the amount of solvent surrounding the fiber near the surface of the etchant and, to a degree, impedes etchant circulation near the reaction interface which affects etch rate to some degree, assisting in taper formation. More significantly, however, as etching proceeds, the upward pulling force resulting from the surface tension decreases due to the reduction of fiber radius in contact with the etchant. Consequently, the meniscus height reduces progressively until the portion of the fiber below the organic solvent/oil is completely etched forming a pointed tip of small diameter.

The properties of the protecting layer determine the shape and contact angle of the meniscus formed and thus the choice of this substance determines the cone angle that is produced. Experimental data indicate that the final tip shape is affected by density difference between the etchant and the protective material and etching temperature as well as the surface tension. It is also possible to alter the tip shape somewhat by vertical movement of the optical fiber during etching.

Selective etching is a suitable alternative etching process for fabricating sensors in accordance with a preferred form of the invention. Selective etching takes advantage of different etch rates exhibited by the optical fiber core and cladding. The tapered tip is formed of core material and, unlike meniscus etching described above, it not formed at the surface of the etchant but deep within the volume of etchant.

For selective etching, a mixture of buffered HF, NH₄F and deionized water is preferably used. If the etching solution contains a volume of NH₄F greater than 1.7 times the volume of other etchant materials the etching speed of the core region is slower than that of the cladding and a tapered shape can thus be developed on the core region since exposed core material is then etched more rapidly at the outer edge of the core than at the center. Conversely, if the volume of NH₄F is less than 1.7 times the volume of other etchant materials the etch rate of the core is greater and an inverted cone shape would be developed (e.g. the core is hollowed). A geometrical model of the selective etching process including relative etch rates is illustrated in FIG. 4B.

A limitation of the two single step etching processes described above is the difficulty of developing a probe tip sharper than about 2 μm. As an alternative capable of producing enhanced sharpening and smaller probe tip diameter, a multi-step etching process (also well-illustrated in FIG. 4B) can be used in which the thickness/diameter of cladding is first reduced by more rapid selective etching of the cladding than of the core followed by sharpening of the core; the reduced cladding thickness/diameter allowing the core to be etched preferentially at its edge. This sequence may be accomplished by, for example, the mixture of the selective etching example discussed above but altering the NH₄F concentration between the two steps of the multi-step etching technique. Other appropriate etchants and procedures will be abundantly evident to those skilled in the art.

By use of a multi-step etching process, probe tip or apex diameters as small as 3 nm have been produced with good reproducibility. Various shapes and tapers can be achieved using different etchants and different numbers of steps as will also be apparent to those skilled in the art.

The above etching techniques, while simple and highly reliable for practice of the invention, suffer from environmental sensitivity. That is, environmental conditions may alter the result achieved by the etching or may compromise the uniformity of the result. One technique to avoid such environmental sensitivity is referred to as tube etching which may be considered as, in essence, a special case of the selective etching process described above.

In tube etching, an etchant is used which selectively etches the core (most rapidly at the periphery thereof) while not etching the cladding at any significant rate. The cladding thus functions as a tube around the core as the etching process proceeds within the tube 42 as illustrated in FIG. 4C. More specifically, the periphery of the core is initially etched slightly faster than the remainder of the core to begin formation of the taper. Once the taper has been thus initiated, convection tends to preferentially deliver HF or other active etchant material to the upper regions of the cone taper; driven by concentration gradients caused by the etching process itself and the gravitational removal of reaction products (e.g. SiO₂ and H₂SiF₆). Depending upon etchants used, the probe tip can be formed either within or at the surface of the etchant. Because of the protected environment of the core and etching process within the cladding tube, this process provides the advantage of resulting in a much smoother surface of the resulting tapered probe and reduced sensitivity to vibrations and temperature fluctuations during the etching process than is provided by other etching processes described above while highly reproducible taper shapes can be developed at high yield.

A variant of tube etching described above is so-called sealed tube etching. In this case a jacket of acrylate or the like (which may be used as the fiber cladding) is permeable to HF or other etchant while the end of the tube is sealed with a material which is impermeable to the same etchant(s). Thus the etchant attacks the core only laterally as the etchant diffuses into the jacket/cladding whereas tube etching allows the etchant to (axially) attack the end of the core as well. As shown in FIG. 4D, this process also allows two probe tips to be formed simultaneously as well as providing somewhat more elongated tapers as an alternative to cleaving, discussed above.

Another etching technique known as the Kwong-Li (KL) method has been recently developed and is particularly suited for practice of the invention for developing probes for biological studies since it is very fast and reliable, requires only a single step and provides sharp angled, elongated probes with taper angles less than 2.1°, nanoscale tip diameters of less than 1 μm and, importantly, probes which can penetrate cellular walls with less mechanical resistance than conventional pipettes and probes fabricated by, for example, meniscus etching, described above.

Essentially, the KL etching method combines a sacrificial boundary etching technique (which provides a tube similar to tube etching) with meniscus etching as described above. This technique of etching is also well illustrated in FIG. 3 with tube 42 formed of glass or the like sacrificial material rather than optical fiber cladding and with a meniscus of etchant of etchant being pulled into region 44 between the core and sacrificial barrier. By controlling etchant height by choice of core and sacrificial boundary dimensions to control lift by the meniscus in the sacrificial barrier, wide flexibility in developing taper length is provided.

In KL etching, the cladding of the optical fiber is initially stripped and a sacrificial glass tubing is provided surrounding the optical fiber core. This glass tube is preferably initially vented at the top but may be closed once etching is started. Close proximity of the fiber core and the sacrificial boundary provides potentially greater etchant lift than in meniscus etching which is readily controllable for control of taper length. During etching, HF etches away the inner wall of the glass tubing allowing the meniscus to fall as etching of the core proceeds as in meniscus etching, described above, but at a controllable and generally slower rate; resulting in a potentially longer taper and a sharply pointed tip. Protection of the core and the etching process also provides a relatively smooth surface of the tapered region as in tube etching described above.

The above described and other etching techniques by which a probe in accordance with the invention may be preferably formed may also be enhanced by additional etching subsequent to the basic etching process such as those described above. For example, HF vapor etching of the entire probe tip surface or a selected portion thereof can be performed to reduce the overall diameter and sharpen the probe. Some etching processes may also serve to improve (e.g. smooth) the surface texture of the probe. It should also be recognized that nanoprobes of the shape and sharpness which can be formed by the above-described techniques can have other important utilities alone or in combination with the invention. For example, nanoprobes can be used for scanning near-field optical microscopy that can develop spatial resolution to 100 nm or less. Thus, in combination with the FP cavity in accordance with the invention, optical observations can be made in conjunction and concurrently with measurements of high accuracy and/or the sensitive detection of particular materials. It should also be appreciated from the above discussion that chemical etching techniques for forming a tapered probe are generally preferable over heating and pulling techniques because of the sharper taper angle and smaller end diameter available with some etching techniques and greater flexibility in regard to more blunt tapers (e.g. 45° or more to the sensor axis or α=90° or more in FIG. 6A) and the correspondingly higher optical transmission efficiencies. However, the final choice of tapering technique should be made in regard to the intended application of the probe, if tapering is indeed desirable in a particular application since tapering is not required for successful practice of the invention in accordance with its basic principles.

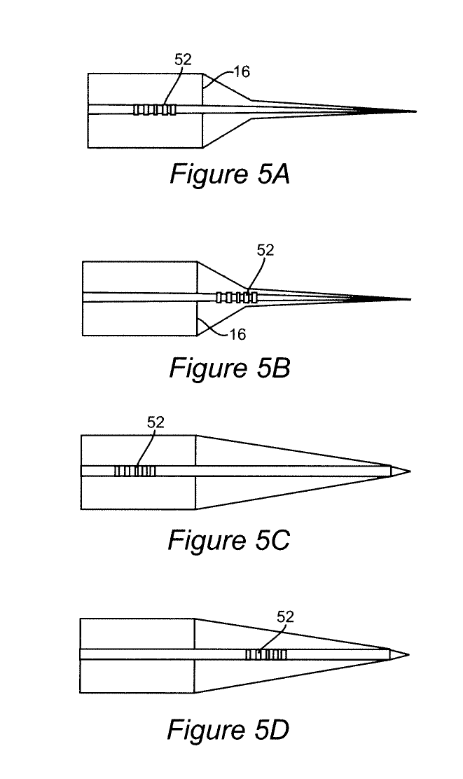

As a structural variation of the invention, it was alluded to above that the first reflector need not be formed as a surface but can be formed by other structures such as a fiber Bragg (diffraction) grating (FBG). FBGs are known and well-understood in the art and generally are formed by regularly or progressively spaced irregularities, such as shallow grooves in the surface of the optical fiber core which are partially reflecting. Such features interact with the wavelength of electromagnetic energy in the fiber to provide interference effects effectively resulting in differing degrees of reflectivity for different wavelengths of elecromagnetic energy in the fiber. The irregularities can be readily formed by known methods in hydrogen loading single mode fiber (SMF). Photosensitive optical fibers are also known which facilitate writing of the grating but hydrogen loading SMF is preferred as a matter of cost. The wavelengths (or wavelength range for a so-called “chirped” grating in which spacing is slightly altered progressively as shown in FIGS. 5A and 5B) at which reflection occurs may be freely chosen by design of the spacing of the irregularities.

The provision of the FBG can substitute for or be in addition to the formation of a junction 16 in the sensor fabrication methodology described above prior to cleaving and optional but preferred tapering of the probe tip, as described above. If the accuracy of cavity length is not critical for a particular application, the length of the cavity may be estimated from a marked point at the general location of the FBG. (The FBG is necessarily of finite length and such a marked point can be at a substantially arbitrary point within the length of the FBG.) Otherwise, if greater accuracy is required for the FP cavity length, two pieces of SMF can be spliced prior to formation of the FBG and the FBG and the cleaving point locations can be determined relative thereto with an accuracy of 2.0 μm or less since the splicing point can be readily observed using a 40X microscope. The location of the FBG can be located inside (e.g. generally corresponding to etching of the junction, alluded to above) or outside the tapered portion of the probe (if, in fact, such a taper is provided) and can be used with any desired taper shape developed as discussed above and at any location relative to a splicing point, if used; examples of which are illustrated in FIGS. 5A-5D in combination with pencil-like tapers or compound tapers; either of which can be at any desired angles to the sensor axis. The resulting effects on the spectrum of energy reflected from the sensor will indicate not only FP cavity length but will also be modulated in accordance with the Bragg length. As with the sensor using a reflective surface for the first reflector, visibility of the spectrum (sometimes referred to as interference fringes or, simply, fringes) can be adjusted by matching of reflectivities of the first reflector (in this case, the Bragg cell or grating) and second reflectors defining a respective FP cavity. Additionally, the reflectivity of the FBG can be adjusted by changing power of the illuminating eletromagnetic energy source, such as a laser, or by changing the Bragg period or the length of the FBG. Thus, use of a FBG can provide several mechanisms to enhance accuracy and sensitivity of a fiber optic sensor in accordance with the invention and is preferred for some applications for that reason. Additionally, since the envelope of the reflected signal is determined by the effect of the FBG on the spectrum which varies only slightly, if at all, with temperature or pressure, the use of an FBG allows intrinsic temperature/pressure compensation.

In view of the foregoing, it is clearly seen that the invention provides an electrically passive sensor of extremely small size with a probe tip in a range potentially extending to a few micrometers or nanometers and which provides a readily detectable signal free from electromagnetic interference (EMI), the visibility of which can be readily maximized and which does not change significantly with reduced tip size. The exterior of the sensor has no abrupt changes in diameter or other irregularities which allows the sensor in accordance with the invention to be robust and compact and resistant to contamination. The sensor in accordance with the invention is simple and inexpensive to fabricate using only a relatively small number of process steps and can be fabricated entirely from fused silica with no required impurities. Hence, it is fully biologically compatible and substantially ideal for in-vivo observations and can be used or treated at temperatures up to 600° C. The sensor structure is highly robust and resistant to breakage even when probe tips are tapered to extremely small dimension; the probe tip tending to elastically bend with large curvature rather than breaking when force is applied thereto. Thus it is seen that the invention provided a sensor having properties suitable for a very wide range of applications particularly where such observations are preferably made with high spatial resolution or in environments of extremely small size such as within a micron-sized cell to which the invention can provide access with minimal invasiveness or disturbance.

The invention also allows certain types of monitoring, detection and/or measurement which has not heretofore been possible as have been alluded to above. As an example, the invention allows detection of nucleic acid (e.g. DNA, RNA) sequences in substantially real time. Known techniques of such detection are complicated, cumbersome, highly invasive, subject to criticalities and require costly and time-consuming analysis whereas the invention can provide this information in substantially real time without a requirement for costly and potentially unreliable selective dyes, labels or indicators. The invention allows hybridization of a complementary DNA strand to an immobilized DNA probe which can be made to adhere only to the fine tip of the sensor probe formed as described above. The probe DNA is preferably immobilized by layer-by-layer electrostatic self assembly (L-b-L ESA) which is described in detail in, for example, “Fuzzy nanoassemblies: toward layered polymeric multicomposites” by G. Desher; Science,, 277, 1232, (1997) which is hereby fully incorporated by reference. The probe tip with the immobilized capture DNA strand is then immersed in a sample. If the DNA sequence in the sample is complementary to the immobilized probe strand, hybridization occurs and the thickness of the probe tip and the length of the FP cavity increases and may be immediately detected as a change in spectral response of the sensor in accordance with the invention. Otherwise, particles of the sample remaining on the probe can be easily rinsed away and, in any event, do not affect effective FP cavity length and do not change the spectral response of the sensor.

This technique of DNA detection has been experimentally confirmed with oligonucleotide sequences ssDNA-A (TCCAGACATGATACATTGATG) (SEQ. ID No:1) as a probe for ssDNA-B (CATCAATGTATCTTATCATGTCTGGA) (SEQ. ID NO:2) and ssDNA-C (CTCACGTTAATGCATTTTGGTC) (SEQ. ID NO:3 as a negative control. After cleaning the fiber sensor 60 with deionized water, polyallylamine hydrochloride (PAH) and polysodium 4-styrenesulfonate (PSS) layers were deposited by alternately immersing the fiber probe tip in the polyelectrolyte solutions (2 mg/ml, pH 5.0) for five minutes. Five bilayers of polymer film were grown with PAH as the outermost surface to form self assembled film 62, as shown in FIG. 6A. The probe was then immersed in ssDNA-A (pH 5.5, concentration 154.17 μg/ml, 0.02M NaCl) for five minutes, rinsed and dried to form a probe film 64. FIG. 6B shows that the DNA was adsorbed onto the probe with a 3.56 nm and 3.38 nm thicknesses using different probes. At this point, fabrication of a probe for detection of a basic DNA sequence is complete. Other binding materials can be used for capturing other materials such as proteins, antigens and antibodies.

These sensors were then immersed in a sample solution including ssDNA-B (pH 5.5, concentration 606 μg/ml, and 0.02 M NaCl) for twenty-five minutes. After capture of ssDNA-B by hybridization, 4.3 and 4.0 nm thickness increases 66 (schematically depicted by a dashed line) were detected; a thickness increase comparable to the multi-layer film thickness and very readily detectable. For the negative control, additional probes were prepared as described above and immersed into the non-complementary ssDNA-C solution (pH 5.5, concentration 123.8 μg/ml, 0.02M NaCl) for forty minutes and sixty minutes, respectively, and no change of film thickness or FP cavity length was observed even though the concentration of non-complementary ssDNA-C was much higher and the immersion time much longer indicating no attachment of ssDNA-C to the probe. This indicates that the invention can provide rapid detection of specific DNA sequences. Other such applications such as detection of particular biological and chemical agents and the appropriate binding materials effective to do so will be apparent to those skilled in the art. Examples of such materials include but are not limited to ; complementary nucleic acid sequences (e.g. DNA, RNA, DNA-RNA hybrids, etc.; various interactive protein species that display, for example, protein-protein interactions, antibody-antigen interactions, or various protein-ligand interactions. Examples of protein-ligand interactions include but are not limited to the binding of enzymes or proteins to substrates, inhibitors, cofactors, allosteric modulators and the like; or the binding to other molcules such as saccharides fatty acids, nucleic acids, etc. Further, detection of the binding of peptides and polypeptides to various ligands is also comprehended. Additionally, the invention is well-adapted to the measurement of intracellular pH by using, for example, any of a number of hydrogels which can exhibit pH-dependent swelling behavior and can be bonded by dipping or growing onto the fiber surface in much the same manner as described above.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A fiber optic sensor comprising
a first reflector,
a second reflector spaced from said first reflector and formed by an end surface of said fiber-optic sensor, said end surface including means for capturing a material thereon,
wherein said first reflector and said second reflector form a Fabry-Perot cavity being variable in length by a thickness of material captured on said end surface.

2. A fiber-optic sensor as recited in claim 1, wherein said first reflector is formed as a surface.

3. A fiber-optic sensor as recited in claim 2, wherein said surface is formed by a junction of two optical fibers.

4. A fiber-optic sensor as recited in claim 3, wherein said two optical fibers have differing mode field diameters.

5. A fiber-optic sensor as recited in claim 1, wherein said first reflector is formed by a fiber Bragg grating.

6. A fiber-optic sensor as recited in claim 5, wherein said fiber Bragg grating is a chirped fiber Bragg grating.

7. A fiber-optic sensor as recited in claim 1 further including a tapered region.

8. A fiber-optic sensor as recited in claim 7 wherein said tapered region tapers to less than one micrometer at said end surface.

9. A fiber-optic sensor as recited in claim 7 wherein said tapered region has a length exceeding a length of said Fabry-Perot cavity.

10. A fiber-optic sensor as recited in claim 7 wherein a taper angle of said tapered region is approximately 2.1°.

11. A fiber-optic sensor as recited in claim 1, further including
a multi-layer self-assembled film and a probe and a capture material.

12. A fiber-optic sensor as recited in claim 11, wherein said capture material includes a DNA sequence complementary to a DNA sequence of interest.

13. A fiber-optic sensor as recited in claim 1, further including a reflective material on lateral sides of said Fabry-Perot cavity.

14. A fiber-optic sensor as recited in claim 1 further including
a reflective material on said end surface.

15. A fiber-optic sensor as recited in claim 1 wherein said first reflector is formed at a junction of said fiber optic sensor and a communication fiber.

16. A method of making a fiber-optic sensor comprising steps of
forming a Fabry-Perot cavity,
attaching a communication fiber at a first end of said Fabry-Perot cavity, and
depositing a material on a second end of said Fabry-Perot cavity, said material being capable of capturing a thickness of additional material, said thickness of additional material effectively altering a length of said Fabry-Perot cavity.

17. A method as recited in claim 16, wherein said step of forming a Fabry-Perot cavity includes a step of splicing optical fibers.

18. A method as recited in claim 16, wherein said step of forming a Fabry-Perot cavity include a step of forming a fiber Bragg grating.

19. A method as recited in claim 16, including a further step of tapering an end portion of said fiber-optic sensor.

20. A method as recited in claim 19 wherein said tapering step is performed by one or more steps including processes of heating and pulling, meniscus etching,, selective etching, tube etching, sealed tube etching, Kwong-Li etching or surface vapor etching.
